(19) United States
(12) Patent Application Publication
(10) Pub. No.: US 2025/0390707 A1
(43) Pub. Date: Dec. 25, 2025

(54) SYSTEMS AND METHODS FOR DYNAMICALLY IDENTIFYING BIAS IN A DATASET

(71) Applicant: Wells Fargo Bank, N.A., San Francisco, CA (US)

(72) Inventors: Swarnava Sinha Roy, Kolkata (IN); Ayan Kundu, Kolkata (IN); Rameshchandra Bhaskar Ketharaju, Hyderabad (IN); Naveen Rathani, Bangalore (IN); Anindya Sil, Kolkata (IN)

(21) Appl. No.: 18/750,930

(22) Filed: Jun. 21, 2024

(51) Int. Cl. G06N 3/045

(52) U.S. Cl. CPC G06N 3/045

(57) ABSTRACT

Systems, apparatuses, methods, and computer program products are disclosed for dynamically identifying bias in a dataset. An example method includes receiving a fine-tuning request and retrieving a machine learning model and a training dataset. The example method further includes during a model training session, determining, using a Uniform Discretized Integrated Gradient (UDIG) technique, that a data element corresponds to biased data and in response to determining that the data element corresponds to biased data, determining a bias identification event. The example method further includes determining a bias mitigation action and causing performance of the bias mitigation action.

### BACKGROUND

A biased model may produce biased outputs, which may expose one or more parties associated with the biased model to risks. As a result, it is crucial for an entity that trains and/or deploys models (e.g., machine learning models) to proactively identify sources of bias. However, various shortcomings and technical challenges exist that make it difficult to identify sources of bias before a model is fully trained.

### BRIEF SUMMARY

Datasets are often used to train machine learning models. In particular, during training, the data elements included in a dataset may provide a machine learning model the inputs and/or outputs necessary for the machine learning model to identify and ultimately learn various patterns and/or relationships that are present in the dataset. Once training is completed, the machine learning model may make predictions and/or classifications based on the identified patterns and/or relationships that were learned from the dataset during training. However, this strong correlation between the identified patterns and/or relationships included in a dataset and the outputs produced by a machine learning model, exposes the machine learning model and the entity (e.g., individual, company, or the like) that deploys and/or uses the machine learning model to unique risks. For example, assume a biased output produced by a machine learning model predicts that a customer's sentiment is happy, even though the customer is actually frustrated. As a result, an employee that uses the output produced by the machine learning model to determine how to interact with a customer may unknowingly misinterpret the customer's true feelings, leading to potential misunderstandings between the customer and the employee. Moreover, biased machine learning models may have long term effects, such as damaging the reputation of the entity that deployed the biased machine learning model. Thus, thoughtful bias mitigation techniques are required to ensure that a machine learning model produces nonbiased and accurate predictions and/or classifications.

To prevent bias from being introduced into a machine learning model during training, entities that train machine learning models may employ a variety of different data collection techniques to ensure that the datasets collected and ultimately used to train machine learning models, comprises high quality data (e.g., nonbiased data). For example, an entity that trains and deploys machine learning models may perform data quality assessments that evaluate the quality of the collected datasets by checking for the completeness, accuracy, or the like, associated with the collected dataset prior to using the collected dataset to train a machine learning model. In particular, an entity may evaluate and remove outliers in the dataset and/or remove any data elements that may impact the overall quality of the particular dataset. In another example, assume that a dataset requires manual annotations or labeling. An entity may require that the one or more annotators that produced the manual annotations are well trained and/or follow standardized guidelines while annotating.

While implementing a variety of different data collection techniques may help detect outliers or missing values in a dataset, the capability of these data collection techniques to investigate the quality of potential training datasets are limited such that they should not be relied upon solely to accurately determine if training a machine learning model using a particular dataset will result in the machine learning model ultimately producing biased outputs. In particular, biases may be unintentionally embedded in a dataset (e.g., a human annotator may be well-trained but may still unintentionally embed biases in their annotations), and subtle biases may be overlooked when evaluating whether a dataset comprises biased data. In addition, it is difficult to predict if a particular machine learning model will learn the biases present in a biased dataset and how these learned biases may manifest in the outputs produced by the machine learning model until the machine learning model is actually trained using the biased dataset.

To evaluate whether a machine learning model has learned any biases during training, many entities that train and/or deploy machine learning models resort to a post-hoc analysis approach (e.g., evaluating whether the machine learning model has learned any biases after the machine learning model is fully trained). For example, assume an entity fully trained a Large Language Model (LLM) for a particular use-case (e.g., sentiment analysis). Once fully trained, the entity may employ any suitable post-hoc analysis technique to determine whether the machine learning model produces biased outputs.

While a post-hoc analysis approach may determine whether the machine learning model has learned any unintentional biases during training, employing a post-hoc analysis approach may be costly to the entity deploying the machine learning model. For example, if a machine learning model is unintentionally biased, the machine learning model may need to be retrained and/or the architecture of the machine learning model may need to be partially or fully restructured. In addition, if the machine learning model has already been deployed and has been producing biased outputs, the entity deploying the machine learning model and its customers using the potentially biased outputs produced by the machine learning model are exposed to risks associated with the users acting upon already produced biased outputs. Moreover, a post-hoc analysis approach does not determine the root cause of the biases learned by a machine learning model, and thus the particular training dataset and data elements included in the training dataset that correspond to biased data are unknown and may be repeatedly used to train future machine learning models. And while an entity may elect to blacklist any training datasets that were used to train a machine learning model that was later determined to be biased, blacklisting may be costly for an entity. For example, an entity may invest significant resources to collect and/or retrieve model training data that would be lost if the training dataset is blacklisted. As a result, a technical need exists for a solution that (i) determines whether a training dataset that is being used during a model training session is unintentionally biasing a machine learning model in real-time and (ii) performs bias mitigation actions that mitigate the risk that traditionally is associated with storing a training dataset that is determined to include biased data.

Additionally, the inherent blind spots and limitations associated with efficiently and accurately identifying bias in datasets presents a technical problem. As such, a need exists for a real-time solution that accurately and efficiently identifies bias in datasets in real-time while a model training session occurs. Example embodiments provide a technical solution to this technical problem because example embodiments do not require manual intervention and instead provide automated bias mitigation techniques based on the particular type of bias identified. Further, by leveraging a Uniform Discretized Integrated Gradients (UDIG) technique to identify bias in datasets, example embodiments provide a technical solution that ensures the efficient and accurate determination of particular data elements included in a biased training dataset that correspond to biased data.

Example embodiments described herein mitigate the above concerns by creating and using a centralized system that leverages a Uniform Discretized Integrated Gradients (UDIG) technique to evaluate feature importance and model behavior during a model training session. To do so, example embodiments may receive a fine-tuning request. The fine-tuning request may be an electronic request that comprises a set of fine-tuning parameters that describe a particular use-case and/or one or more rules and/or conditions to follow while training (e.g., fine-tuning) a machine learning model for the particular use-case. For example, the set of fine-tuning parameters may include a description or an indication of the particular use-case associated with the fine-tuning request (e.g., text that indicates a use case, such as sentiment analysis, text summarization, language translation, and/or the like), data requirements (e.g., the type of data and/or volume of data required for training), the base model architecture of the machine learning model (e.g., Bidirectional Encoder Representations from Transformers (BERT), Generative Pre-trained Transformer (GPT), or the like), any constraints or considerations that may be considered during training (e.g., regulatory requirements, or the like), and/or the like. Example embodiments may then retrieve the machine learning model (e.g., a pre-trained machine learning model, such as a large language model (LLM)) and a training dataset that comprises a plurality of data elements (e.g., characters, tokens, and/or the like), which may be used to fine-tune the machine learning model for a particular use-case.

Example embodiments may also train (e.g., fine-tune) the machine learning model using the training dataset during a model training session. A model training session may refer to a particular period of time when the machine learning model is training (e.g., fine-tuning) using the training dataset for a particular use-case. For example, during a model training session, the machine learning model may use the training data set to iteratively update its parameters to better predict a next token in a sequence given a preceding context (e.g., preceding tokens included in the training dataset). While the model training session occurs, example embodiments may apply a Uniform Discretized Integrated Gradient (UDIG) technique to determine whether a data element included in the training dataset corresponds to biased data. In addition, example embodiments may repeatedly (e.g., periodically) apply the UDIG technique during the model training session, such that bias may be dynamically identified as the model training session occurs.

Example embodiments may also, in an instance in which the data element type is determined to correspond to biased data, determine a bias identification event. A bias identification event may refer to a category associated with a particular data element included in the training data set that corresponds to biased data. In some embodiments, the bias identification event may correspond to a bias identification event type, which may correspond to the particular biased data to which the particular data element corresponds. In some embodiments, the bias identification event type may be associated with and/or indicate the severity of the bias identification event. Example embodiments may also determine, based on the bias identification event type, a bias mitigation action. The bias mitigation action may refer to a particular operation (e.g., soft locking the dataset, a debiasing technique, blacklisting the dataset, and/or the like) that mitigates the risk associated with the biased dataset. Example embodiments may further cause performance of the bias mitigation action. For example, a soft lock may be applied to the training dataset. A soft lock may refer to a mechanism that restricts the access or usage of a particular dataset (e.g., a training dataset) or particular data elements included in a particular dataset, while not entirely preventing access (e.g., user access) to the particular dataset.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for dynamically identifying bias in a dataset, in accordance with some example embodiments described herein.

FIG. 4 illustrates an example flowchart for using a UDIG technique to determine whether a data element corresponds to biased data, in accordance with some example embodiments described herein.

FIG. 5 illustrates an example flowchart for performing a bias mitigation action, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

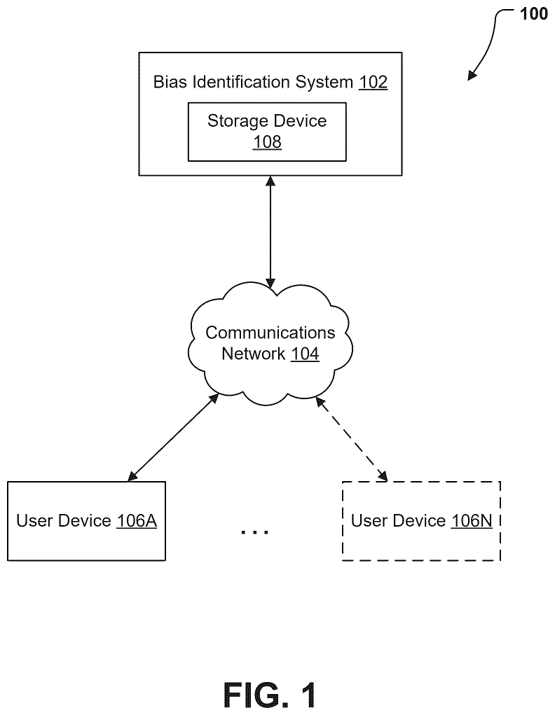

Example embodiments described herein may be implemented using any of a variety of computing devices or servers. To this end, FIG. 1 illustrates an example environment 100 within which various embodiments may operate. As illustrated, a bias identification system 102 may receive and/or transmit information via communications network 104 (e.g., the Internet) with any number of other devices, such as one or more of user devices 106A-106N.

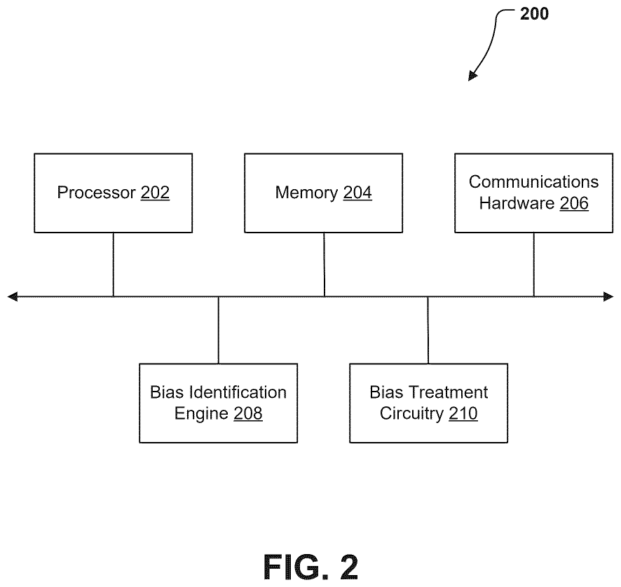

The bias identification system 102 may be implemented as one or more computing devices or servers, which may be composed of a series of components. Particular components of the bias identification system 102 are described in greater detail below with reference to apparatus 200 in connection with FIG. 2.

In some embodiments, the bias identification system 102 further includes a storage device 108 that comprises a distinct component from other components of the bias identification system 102. Storage device 108 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 108 may host the software executed to operate the bias identification system 102. Storage device 108 may store information relied upon during operation of the bias identification system 102, such as various algorithms that may be used by the bias identification system 102, data and documents to be analyzed using the bias identification system 102, or the like. In addition, storage device 108 may store control signals, device characteristics, and access credentials enabling interaction between the bias identification system 102 and one or more of the user devices 106A-106N.

The one or more user devices 106A-106N may be embodied by any computing devices known in the art. The one or more user devices may be associated with a user that is associated with an entity that is providing the bias identification service provided by bias identification system 102. The one or more user devices 106A-106N need not themselves be independent devices but may be peripheral devices communicatively coupled to other computing devices.

### Example Implementing Apparatuses

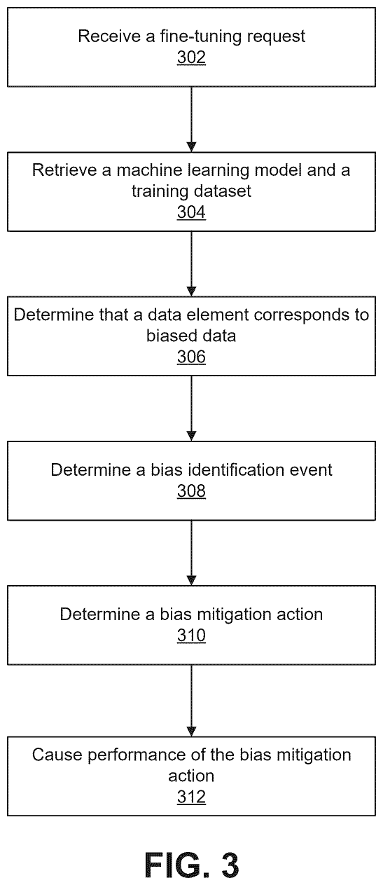

The bias identification system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-5. As illustrated in FIG. 2, the apparatus 200 may include processor 202, memory 204, communications hardware 206, bias identification engine 208, and bias treatment circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

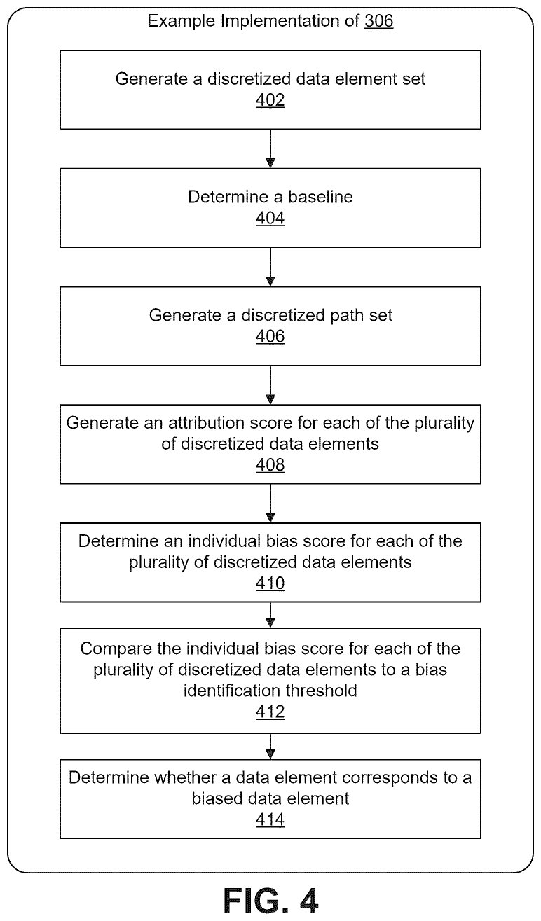

In addition, the apparatus 200 further comprises a bias identification engine 208 that determines, using a Uniform Discretized Integrated Gradient (UDIG) technique, whether the data element type corresponds to biased data. In addition, bias identification engine 208 determines a bias identification event in the instance in which a data element type is determined to correspond to biased data. Further, bias identification engine 208 determines a bias mitigation action and causes performance of the bias mitigation action. The bias identification engine 208 may utilize processor 202, memory 204, or any other hardware component included in the apparatus 200 to perform these operations, as described in connection with FIGS. 3-4 below. The bias identification engine 208 may further utilize communications hardware 206 to gather data from a variety of sources (e.g., user device 106A-106N or storage device 108, as shown in FIG. 1), and/or exchange data with a user, and in some embodiments may utilize processor 202 and/or memory 204.

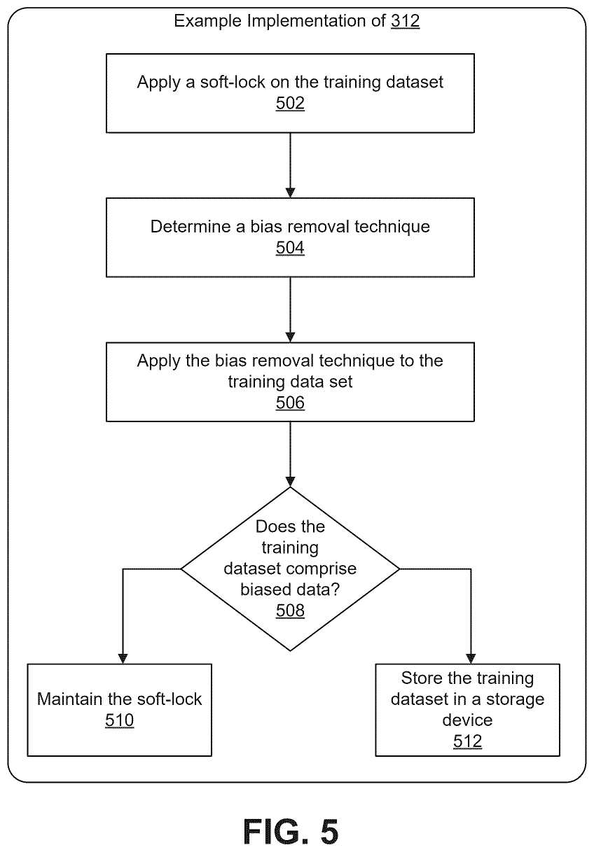

Further, the apparatus 200 further comprises a bias treatment circuitry 210 that determines a bias mitigation action. In addition, bias treatment circuitry 210 causes performance of the bias mitigation action. Bias treatment circuitry 210 may utilize processor 202, memory 204, or any other hardware component included in the apparatus 200 to perform these operations, as described in connection with FIG. 3 and FIG. 5 below. The bias treatment circuitry 210 may further utilize communications hardware 206 to gather data from a variety of sources (e.g., user device 106A through user device 106N or storage device 108, as shown in FIG. 1), and/or exchange data with a user, and in some embodiments may utilize processor 202 and/or memory 204.

Although components 202-210 are described in part using functional language, it will be understood that the particular implementations necessarily include the use of particular hardware. It should also be understood that certain of these components 202-210 may include similar or common hardware. For example, the bias identification engine 208 and bias treatment circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the bias identification engine 208 and bias treatment circuitry 210 may leverage processor 202, memory 204, or communications hardware 206 as described above, it will be understood that any of bias identification engine 208 and bias treatment circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that bias identification engine 208 and bias treatment circuitry 210 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts.

### Example Operations

Turning to FIGS. 3-5, example flowcharts are illustrated that contain example operations implemented by example embodiments described herein. The operations illustrated in FIGS. 3-5 may, for example, be performed by bias identification system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, bias identification engine 208, bias treatment circuitry 210, and/or any combination thereof. It will be understood that user interaction with the bias identification system 102 may occur directly via communications hardware 206, or may instead be facilitated by a separate user device (e.g., user device 106A, as shown in FIG. 1, and which may have similar or equivalent physical componentry facilitating such user interaction.

Turning first to FIG. 3, example operations are shown for dynamically identifying bias in a dataset.

As shown by operation 302, the apparatus 200 includes means, such as processor 202, memory 204, communications hardware 206, or the like, for receiving a fine-tuning request. A fine-tuning request may be an electronic request that comprises a set of fine-tuning parameters that describe a particular use-case and/or one or more rules and/or conditions to follow while training (e.g., fine-tuning) a machine learning model for the particular use-case. For example, the set of fine-tuning parameters may include a description or an indication of the particular use-case associated with the fine-tuning request (e.g., text that indicates a use case, such as sentiment analysis, text summarization, language translation, and/or the like), data requirements (e.g., the type of data and/or volume of data required for training), the base model architecture of the machine learning model (e.g., BERT, GPT, or the like), any constraints or considerations that may be considered during training (e.g., regulatory requirements, or the like), and/or the like.

In some embodiments, the apparatus 200 may receive a fine-tuning request from a computing device associated with a user (e.g., an individual associated with an entity, such as a company, government agency, or the like). For example, communications hardware 206 may receive the fine-tuning request from user device 106A via a network (e.g., communications network 104, shown in FIG. 1). In some embodiments, upon receiving the fine-tuning request, the fine-tuning request may be stored in a local storage device (e.g., memory 204, storage device 108, or the like). Additionally, bias identification engine 208 may utilize any suitable technique (e.g., Natural Language Processing (NLP)) to identify the set of fine-tuning parameters that are included in the fine-tuning request, and subsequently store the set of fine-tuning parameters in a local storage device. Alternatively, the set of fine-tuning parameters may simply remain in the fine-tuning request, such that if apparatus 200 requires a parameter or the set of fine-tuning parameters, the apparatus 200 may simply retrieve the fine-tuning request from a local storage device.

As shown by operation 304, the apparatus 200 includes means, such as processor 202, memory 204, communications hardware 206, bias identification engine 208, or the like, for retrieving a machine learning model and a training dataset. In some embodiments, the machine learning model may be a large language model (LLM) that may be generally trained on a large corpus of text data. In particular, the generally trained LLM's may be generally trained by (i) initializing the LLM (e.g., initializing the parameters (weights and biases) of the neural network with random values), (ii) defining a training objective (e.g., predicting a next word), and (iii) training the LLM (e.g., via an unsupervised approach) and updating the LLM's parameters every training iteration. In some embodiments, the machine learning model may be trained using a large training corpus stored in a local storage device (e.g., storage device 108, or the like). This general training process may enable the LLM to develop a broad understanding of language patterns, grammar, syntax, semantics, and/or the like. And while the LLM is generally trained, the LLM may often be required to be fine-tuned for a particular use-case (e.g., sentiment analysis, language translation, or the like).

In some embodiments, the training dataset may be a dataset that comprises a plurality of data elements that may be used to fine-tune a machine learning model for a particular use case. In this regard, the training dataset may comprise labeled data elements that are relevant to a particular use-case. For example, a training dataset that is used to fine-tune a machine learning model for a sentiment analysis use-case may include a plurality of articles comprising text with labels that indicate the particular sentiment associated with a particular word. In some embodiments, a local storage device, such as memory 204, storage device 108, or the like, may store a plurality of training datasets that are each are labeled, such that the label associates a particular dataset with one or more use-cases. As a result, bias identification engine 208 may select a particular training dataset based on its corresponding label.

To select and retrieve a machine learning model and training dataset, bias identification engine 208 may retrieve the set of fine-tuning parameters from a local storage device and subsequently utilize the set of fine-tuning parameters to select and ultimately retrieve a machine learning model and training dataset that correspond to the rules and conditions outlined by the set of fine-tuning parameters. For example, a plurality of machine learning models and a plurality of training datasets may be stored in a local storage device (e.g., memory 204, storage device 108, or the like). The plurality of machine learning models and training datasets may be of various categories and be associated with a variety of different labels that correspond to particular use-cases, architectures, or the like. For example, each training dataset of the plurality of training datasets may correspond to a particular use-case based on the particular data elements included in each training dataset. In addition, the plurality of machine learning models may each correspond to a particular architecture, such as a transformer architecture, long short-term memory network (LSTM), and/or the like. In such an embodiment where a plurality of training datasets and a plurality of machine learning models are stored in a local storage device, bias identification engine 208 may select and retrieve a machine learning model and training dataset that is most similar to or satisfies the rules and/or conditions described by the set of fine-tuning parameters. For example, assume the set of fine-tuning parameters describes a particular machine learning model and/or training dataset to utilize for fine-tuning. In this regard, bias identification engine 208 may simply retrieve the training dataset and/or machine learning model indicated by the set of fine-tuning parameters. In another example, the fine-tuning request may simply describe a particular model architecture and use-case. As such, bias identification engine 208 may use any suitable method, such as NLP, to search (i) the metadata associated with each model or training dataset for an indication of the requested model architecture (e.g., models may be labeled as having a transformer architecture) and/or training dataset and/or (ii) the name of the model and/or training dataset (e.g., GPT, BERT, sentiment analysis training dataset, or the like have an indicator of their architecture or particular use-case in their name).

Alternatively, a plurality of machine learning models and/or plurality of training datasets may be stored in an external storage device (not pictured in FIG. 1) that is connected to the apparatus 200 via a network (e.g., communications network 104, shown in FIG. 1). In such an embodiment, bias identification engine 208 may leverage communications hardware 206 to transmit a component request to an external storage device that comprises the plurality of machine learning models and/or plurality of training datasets. The component request may be an electronic request that is generated by the bias identification engine 208. In this regard, bias identification engine 208 may generate the component request such that it comprises any necessary authentication credentials (e.g., an Application Programming Interface (API) key, username and password, and/or the like) and an indication of the requested components (e.g., a particular machine learning model and/or a particular training dataset). Subsequently, bias identification engine 208 may leverage communications hardware 206 to transmit the component request via a network (e.g., communications network 104, shown in FIG. 1) to the external storage device, such that the external storage device may then utilize the received electronic request to search its repository for the requested training dataset and/or machine learning model. Thereafter, communications hardware 206 may receive via communications network 104, the requested machine learning model and/or training dataset from the external storage device, and subsequently store the received machine learning model and/or training dataset in a local storage device (e.g., memory 204, storage device 108, and/or the like).

As shown by operation 306, the apparatus 200 includes means, such as processor 202, memory 204, bias identification engine 208, or the like, for determining that a data element corresponds to biased data. Biased data may refer to a data element that comprises an incorrect annotation, a data element that corresponds to nonuniform data, or the like, such that when a machine learning model uses the biased data for training, the machine learning model may learn a bias associated with the biased data element, which may cause the machine learning model to ultimately produce inaccurate and/or biased outputs.

In some embodiments, bias identification engine 208 may determine whether a data element corresponds to biased data during a model training session. A model training session may refer to a particular period of time when the machine learning model is training (e.g., fine-tuning) using the training dataset for a particular use-case. For example, during a model training session, the machine learning model may use the training dataset to iteratively update its parameters to better predict a next token in a sequence given a preceding context (e.g., preceding tokens included in the training dataset).

In some embodiments, operation 306 may be performed in accordance with the operations described by FIG. 4. Turning now to FIG. 4, example operations are shown for using a uniform discretized integrated gradient (UDIG) technique to determine whether a data element corresponds to biased data during a model training session. Additionally, during a model training session, the UDIG technique may be applied periodically, such that the operations described in FIG. 4 are in turn performed a plurality of times throughout a model training session. Moreover, the periodic application of the UDIG technique enables the apparatus 200 (e.g., bias identification engine 208) to identify bias in a training dataset at different stages (e.g., training iterations) of a model training session, and thus allows for the dynamic identification of bias in a training dataset, such that bias in the training dataset may be identified throughout the model training session.

As shown by operation 402, the apparatus 200 includes means, such as processor 202, memory 204, bias identification engine 208, or the like, for generating a discretized data element set. In some embodiments, if the training dataset comprises discretized data, the discretized data element set may be the training dataset. Alternatively, if the training dataset does not comprise a discrete set of data elements, bias identification engine 208 may discretize the data elements included in the training dataset.

In some embodiments, bias identification engine 208 may use a set of discretization rules that may be stored in a local storage device, such as memory 204, storage device 108, or the like, to determine how to discretize the data elements included in the training dataset. As such, the set of discretization rules may describe particular discretization techniques (e.g., tokenization algorithms, word embedding methods, or the like) to apply to discretize a particular training dataset. For example, assume the training dataset comprises a plurality of characters. As a result, bias identification engine 208 may retrieve the set of discretization rules, which may include instructions for the bias identification engine 208 to utilize a particular tokenization algorithm to tokenize (e.g., discretize) the plurality of characters included in the training dataset and then subsequently calculate a word embedding based on a word embedding method (e.g., word2vec) for each generated token. Thereafter, bias identification engine 208 may store the generated discretized data elements in a discretized data element set in a local storage device. For example, bias identification engine 208 may store the discretized data element set in memory 204, storage device 108, and/or the like.

The above-described discretization of the training dataset allows for the bias identification engine 208 to be able to efficiently determine particular data elements that correspond to biased data (described in more detail further below). For example, tokenizing a plurality of characters prior to applying a UDIG technique allows for the later applied UDIG technique to be applied to particular tokens instead of simply being applied to a plurality of non-tokenized characters (e.g., alphanumeric characters, whitespaces, special characters, or the like), and thus allows for the determination of the particular influence a particular token may have on the output (e.g., an overall sentiment prediction) produced by a machine learning model. Additionally, discretizing the training dataset (e.g., generating a discretized data set) allows for the applied UDIG technique to be applied across various machine learning models architectures and various input types. For example, regardless of the input type or model architecture, the input features are converted into a common format of discrete data elements, and thus may be evaluated via a UDIG technique. Moreover, integrated gradient techniques generally require a discretized input, and thus the above-described discretization is crucial to ensure that the training dataset is compliant for the applied UDIG technique that is described in detail further below.

As shown by operation 404, the apparatus 200 includes means, such as processor 202, memory 204, bias identification engine 208, or the like, for determining a baseline. The baseline may be a zero vector, a vector with neutral values, or the like, such that the baseline is a reference against which the discretized data elements included in the discretized data element set may be compared against. For example, bias identification engine 208 may define the baseline as a sequence of padding tokens that represents a sequence of empty or neutral data elements (e.g., [PAD], [PAD], . . . , [PAD]). In another example, assume the discretized data element set includes the tokens “The” “movie” “was” “excellent” “and” “the” “acting” “was” “outstanding”. In this regard, bias identification engine 208 may define a baseline input as “The” “movie” “was” “neutral” “and” “the” “acting” “was” “neutral”. In some embodiments, the type of baseline (e.g., a sequence of padding tokens, or the like) may be determined based on the particular use-case defined by the set of fine-tuning parameters. In such an embodiment, bias identification engine 208 may retrieve the set of fine-tuning parameters and a set of baseline determination rules from a local storage device (e.g., memory 204, storage device 108, or the like) that describes the particular baseline associated with a particular use-case to determine a baseline that corresponds to the particular use-case indicated in the retrieved set of fine-tuning parameters.

As shown by operation 406, the apparatus 200 includes means, such as processor 202, memory 204, bias identification engine 208, or the like, for generating a discretized path set. The discretized path set may comprise one or more paths from the baseline to an actual sequence of discretized data elements that are included in the discretized data element set. For example, assume the discretized data element set comprises the tokens “This” “movie” “is” “great”. As such, the discretized path set may include a path that describes the transition (e.g., a set of gradual transitions) from the baseline (e.g., a sequence of padding tokens) to the actual sequence included in the discretized data element set. For example, one possible path from a baseline of padding tokens to the actual sequence of “This” “movie” “is” “great” may be: [PAD] [PAD] [PAD] [PAD], [PAD] [PAD] [PAD] This, [PAD] [PAD] This movie, [PAD] This movie is, This movie is great. Once the path is determined, bias identification engine 208 may store the determined path in a discretized path set. In some embodiments the discretized path set may be stored in a local storage device (e.g., memory 204, storage device 108, or the like).

In some embodiments, the discretized path set comprises a plurality of different paths associated with the same sequence from the discretized data element set (e.g., “This” “movie” “is” “great”). Each of the plurality of different paths may begin with the same determined baseline and end with the actual sequence from the discretized data element set. However, the incremental steps from the baseline to the actual input sequence may vary among the plurality of different paths. Continuing the above example where the input sequence is “This” “movie” “is” “great”, an additional path included in the discretized path set may be: [PAD] [PAD] [PAD] [PAD], [PAD] [PAD] [PAD] great, [PAD] [PAD] is great, [PAD] movie is great, The movie is great.

The generation of a plurality of different paths allows for the apparatus 200 (e.g., bias identification engine 208, or the like) to provide a particular determination of whether a particular data element corresponds to biased data to not be overly dependent on a particular path choice. Moreover, the plurality of different paths may capture various aspects of token importance, which allows for a more comprehensive coverage of the input sequence than if only a singular path was included in the discretized path set. For example, a token that contributes consistently to the model output across different contexts or paths may indicate that the token does not correspond to biased data. However, if a particular token's contribution varies across different contexts or paths, this variation may indicate that the particular token corresponds to biased data. To this end, the exploration of a plurality of paths can uncover edge cases or corner scenarios where a particular token may exhibit unexpected importance, and thus indicate that the particular token corresponds to biased data.

As shown by operation 408, the apparatus 200 includes means, such as processor 202, memory 204, bias identification engine 208, or the like, for generating an attribution score for each data element included in the discretized data element set. In this regard, the attribution score may correspond to a particular discretized data element include in the discretized data element set and to a particular path in the discretized path set. An attribution score may be a numerical score that indicates the significance (e.g., influence) that a particular data element has on the output (e.g., a sentiment prediction) produced by the machine learning model. In some embodiments, the attribution score for each data element included in the discretized data element set may be generated by the bias identification engine 208. In particular, bias identification engine 208 may apply a UDIG technique to each data element along each of the plurality of different paths included in the discretized path set to which each data element corresponds.

More particularly, to generate an attribution score for each data element included in each of the plurality of different paths included in the discretized path set, the bias identification engine 208 may retrieve the discretized path set from a local storage device (e.g., memory 204, storage device 108, or the like) and subsequently apply a UDIG technique to each path included in the discretized path set. In some embodiments, the applied UDIG technique may produce a corresponding attribution score for each data element included in the discretized data element set. In particular, the applied UDIG technique may calculate gradients (e.g., partial derivatives of the model's output with respect to a discretized data element included in the discretized data element set) along a particular path (e.g., one of the plurality of different paths included in the discretized path set) from the determined baseline to an actual sequence of discretized data elements. As such, a gradient may be calculated at each incremental step outlined in the particular path included in the discretized path set. For example, assume a determined baseline of padding tokens and an input sequence (e.g., from the discretized data element set) of “This” “movie” “was” “great”. In this regard, a path included in the discretized path set may be [PAD, PAD, PAD, PAD], [PAD, PAD, PAD, This], [PAD, PAD, This, movie], [PAD, This, movie, was], [This, movie, was, great]. As a result, bias identification engine 208 may apply a UDIG technique that calculates a gradient of a particular data element included in the input sequence, such as “great”, with respect to the input sequence at each step included in the above example path. This process may be repeated for each discretized data element included in the particular path. Moreover, this gradient calculation process that may be repeated for each discretized data element may in turn be repeated for each path included in the discretized path set.

Thus, the applied UDIG technique, which explores various paths, explores a comprehensive set of input configurations allowing for a highly accurate and robust determination of whether a particular discretized data element corresponds to biased data. In addition, since the UDIG technique is applied (and may be applied periodically) by the bias identification engine 208 during a model training session, a biased data element may be determined throughout the training process and prior to the deployment of the trained machine learning model, which allows for corrective action (as described further below in relation to FIG. 5) to be taken and ultimately mitigate the risk involved with storing a training dataset with biased data to fine-tune a machine learning model for a particular use-case.

Upon calculating the gradients in the manner described above, bias identification engine 208 may integrate the gradients associated with a particular data element that were calculated along the same path. In other words, bias identification engine 208 may calculate a summation of each gradient calculated at each incremental step outlined in a particular path that is include in the discretized path set to generate an attribution score for a particular data element. Since the attribution score is based on the calculated gradients along a particular path, the attribution score may be associated with a particular path included in the discretized path set in addition to corresponding with a particular data element. In some embodiments, as mentioned above, bias identification engine 208 may repeat the above-described UDIG technique by utilizing the below formula to calculate an attribution score for each discretized data element included in each particular path included in the discretized path set:

$$Uniform Discretized IG ( {x}_{i} ) = {\int }_{{x}_{i}^{k} = {x}^{′}}^{{x}_{i}} \frac{\partial F ( {x}^{k} )}{\partial {x}_{i}} {dx}_{i}^{k} ; \qquad ( 1 )$$

where

$${x}_{i}^{k}$$

is the k^{th} data element between the input x and baseline x′, and F is a neural network (e.g., the neural network associated with the machine learning model that is using the training dataset for training during the model training session).

In some embodiments, bias identification engine 208 may store each generated attribution score that corresponds with a particular data element that is included in the discretized data element set in an attribution score dataset that corresponds with the particular data element. For example, the attribution scores determined for data element A by bias identification engine 208 using path 1, path 2, and path 3 may be stored in a first attribution score dataset and the attribution scores determined for data element B by bias identification engine 208 using path 1, path 2, and path 3 may be stored in a second attribution score dataset. In some embodiments, bias identification engine 208 may store the attribution score dataset in a local storage device, such as memory 204, storage device 108, and/or the like.

As shown by operation 410, the apparatus 200 includes means, such as processor 202, memory 204, bias identification engine 208, or the like, for determining an individual bias score for each data element included in the discretized data element set (e.g., the plurality of discretized data elements). An individual bias score may be a numerical score that indicates the probability that a particular data element included in the discretized data element set corresponds to biased data. For example, the individual bias score may be a numerical score between the values of 0 and 1, where a value closer to 0 indicates that the particular data element does not correspond to biased data and a value closer to 1 indicates that the particular data element does correspond to biased data. In some embodiments, the individual bias score may not be a numerical score but may be a categorical result, such as tier 1/tier 2/tier 3, green, yellow, red, or some other type of categorical result.

In some embodiments, the individual bias score for a particular data element may be determined based on the one or more attribution scores included in the attribution score dataset (e.g., attribution scores associated with different paths but correspond to the same data element and are stored in an attribution score dataset). For example, assume the discretized path set includes three different paths. Thus, the above-described UDIG technique was applied for three different paths, where each of the three different paths yielded an attribution score for a particular data element (e.g., 0.6, 0.8, 0.7). Bias identification engine 208 may then calculate an individual bias score for the particular data element by using any suitable technique to combine the three attribution scores. For instance, bias identification engine 208 may determine that the individual bias score for a particular data element by calculating an average of the three scores, a weighted average of the three scores, or the like. In some embodiments, each individual bias score determined by bias identification engine 208 may be stored in association with the particular data element (e.g., a particular data element included in the discretized data element set) to which it corresponds. For example, bias identification engine 208 may store, in a local storage device, the individual bias score and the data element to which the individual bias score corresponds in the form of key-value pairs where the key is the particular data element, and the value is the individual bias score.

As shown by operation 412, the apparatus 200 includes means, such as processor 202, memory 204, bias identification engine 208, or the like, for comparing the individual bias score for each of the plurality of discretized data elements to a bias identification threshold. The bias identification threshold may be a predetermined threshold. For example, the entity that is providing the bias identification service offered by the apparatus 200 may have a set of predetermined thresholds stored in a local storage device, such as memory 204, storage device 108, or the like. In some embodiments, the bias identification threshold may vary depending on the particular use-case that is described and/or indicated in the set of fine-tuning parameters. For example, if a particular use-case involves the use of personal identifiable information (PII), the bias identification threshold may be lower, such that the bias identification threshold is more likely to be satisfied. In another example, if the particular use-case does not involve PII and/or the particular use-case is not deployed to customers, but instead is only deployed internally, the bias identification threshold may be higher, and thus may be more difficult to satisfy.

In some embodiments, bias identification engine 208 may retrieve (e.g., from a local storage device) and use the set of fine-tuning parameters, which may describe a particular use-case, to identify a bias identification threshold that corresponds to the particular use-case. For example, a local storage device, such as memory 204, storage device 108, or the like may include a set of bias identification threshold rules that describe conditions and/or rules associated with a particular bias identification threshold. Once the bias identification threshold is determined, bias identification engine 208 may retrieve the individual bias scores, which indicate the particular data element to which the individual bias score corresponds, from a local storage device to compare each individual bias score to the bias identification threshold and ultimately determine based on the comparison whether the particular data element corresponds to a biased data element.

As shown by operation 414, the apparatus 200 includes means, such as processor 202, memory 204, bias identification engine 208, or the like, for determining whether a data element corresponds to a biased data element. A biased data element may refer to a particular data element included in the discretized data element set that is associated with an individual bias score that satisfies the bias identification threshold. As a result, if an individual bias score associated with a particular data element satisfies the bias identification threshold, bias identification engine 208 may determine that the particular data element corresponds to a biased data element. Alternatively, if the individual bias score does not satisfy the bias identification score threshold, bias identification engine 208 may determine that the particular data element does not correspond to a biased data element.

Returning to FIG. 3, as shown by operation 308 the apparatus 200 includes means, such as processor 202, memory 204, communications hardware 206, bias identification engine 208, or the like, for determining a bias identification event. A bias identification event may refer to a category associated with a particular data element included in the discretized data element set that corresponds to biased data. In some embodiments, the bias identification event may correspond to a bias identification event type, which may correspond to the particular biased data to which the particular data element corresponds. In some embodiments, the bias identification event type may be associated with and/or indicate the severity of the bias identification event. In particular, a bias identification event type may be considered severe, moderate, low, or the like, based on the individual bias score associated with the particular data element that corresponds to biased data.

In some embodiments, bias identification engine 208, may utilize a bias identification model to determine a particular bias identification event type. For example, assume the data element (e.g., a particular token and/or word embedding) that corresponds to biased data is associated with a protected class (e.g., race, gender, age, and/or the like). In this regard, bias identification engine 208 may provide the data element that corresponds to biased data and its corresponding individual bias score, such that the bias identification model may determine a bias identification event type for the data element that corresponds to biased data.

As shown by operation 310, the apparatus 200 includes means, such as processor 202, memory 204, communications hardware 206, bias treatment circuitry 210, or the like, for determining a bias mitigation action. The bias mitigation action may refer to a technical action that may be executed to mitigate the bias identified in the training dataset (e.g., cause removal of the bias identification event). For example, the bias mitigation action may include implementing a soft lock, applying bias removal techniques to remove the bias from the training dataset, and/or the like.

In some embodiments, the bias mitigation action may be determined based on the bias identification event type. For example, a local storage device (e.g., memory 204, storage device 108, or the like) may include a bias mitigation action list that describes a list of bias mitigation actions that may be performed to mitigate the risk associated with a particular type of biased data. The list of bias mitigation actions may comprise of a list of bias mitigation actions that may be performed to cause removal of a particular corresponding bias identification event type. For example, the list of bias mitigation action may store the bias mitigation actions and bias identification event types in the form of key-value pairs, where the key corresponds to a particular bias identification event type and the value corresponds to a particular bias mitigation action. As a result, bias treatment circuitry 210 may utilize the bias mitigation action list to determine a bias mitigation action that when performed (described below in relation to operation 312) may cause removal of the bias identification event type.

As shown by operation 312, the apparatus 200 includes means, such as processor 202, memory 204, communications hardware 206, bias treatment circuitry 210, or the like, for causing performance of the bias mitigation action. In some embodiments, the performance of the bias mitigation action may be automatically performed in response to a bias mitigation action automatic triggering event. A bias mitigation action automatic triggering event may include a circumstantial trigger event, and/or the like. A circumstantial trigger event may take place based on rules and/or configuration predefined by the entity that is providing the bias identification service provided by the bias identification system 102 that requires the performance of a bias mitigation action in response to the determination of the bias identification event type. For example, bias identification engine 208 may configure a circumstantial trigger that causes the apparatus 200 (e.g., bias treatment circuitry 210, or the like) to apply a soft lock to the training data set that is associated with the data element that corresponds to biased data. In another example, bias identification engine 208 may configure a circumstantial trigger that causes communications hardware 206 to transmit a message to a user associated with the fine-tuning request (e.g., a user associated with the computing device, such as user device 106A, user device 106N, or the like, that transmitted the fine-tuning request) that notifies the user of the identified bias (e.g., the message may include an indication of the determined bias identification event type, or the like).

In some embodiments, operation 312 may be performed in accordance with the operations described by FIG. 5. Turning now to FIG. 5, example operations are shown for causing performance of a bias mitigation action.

As shown by operation 502, the apparatus 200 includes means, such as processor 202, memory 204, communications hardware 206, bias treatment circuitry 210, or the like, for applying a soft lock to the training dataset. A soft lock may refer to a mechanism that restricts electronic access or usage of a particular dataset or particular data elements included in a dataset, while not completely preventing access to the particular dataset. For example, while a soft lock is applied to a dataset (e.g., the training dataset), certain actions, such as limiting particular users to read-only access, data analysis, data cleaning, or any other action that does not involve altering the fundamental structure or distribution of the data, may be performed by the system itself or a user associated with the system. However, other actions that may increase the likelihood of the transmission of bias from the biased data elements present in the training dataset to other applications, such as using the dataset for model training, sharing the dataset with external parties or systems, and/or the like, may be restricted.

In some embodiments, the application of a soft lock to the training dataset that comprises biased data elements may allow for the apparatus 200 to perform corrective actions (e.g., bias removal techniques, or the like) while the soft lock is in place. Entities often invest significant resources in collecting or acquiring datasets that are used for model training. As such, applying a soft lock may allow for an entity that acquired or collected a training dataset that comprises biased data elements to continue to utilize the dataset for non-production purposes while addressing (e.g., removing) the biased data elements, thus maximizing the entities return on investment. Moreover, soft locking a training dataset with identified biased data elements allows for a more flexible approach to managing biased data. For example, varying degrees of restrictions may be applied while a dataset is soft locked based on the severity (e.g., the bias identification event type) associated with the corresponding biased data elements.

In some embodiments, the training dataset may be stored in a local storage device, such as memory 204, storage device 108, or the like. As a result, to apply the soft lock, bias treatment circuitry 210 may alter who may access the dataset. For example, users with appropriate privileges, such as data scientists or analysts, may be allowed to access the dataset for analysis or review while the soft lock is applied. However, model developers or application developers, may have restricted access to the training dataset.

In some embodiments, the apparatus 200 may require a user to transmit (e.g., via any one of user device 106A through user device 106N) a data access request that comprises authentication information about the user (e.g., biometric data, username and password, or the like) and/or a user identifier (e.g., a username) to the apparatus 200 (e.g., communications hardware 206) prior to determining whether the user may be granted access to the training dataset. As a result, upon receiving the data access request, the apparatus 200 may verify the user via the authentication information and subsequently determine the role associated with the verified user to determine whether the user may be granted access to the training dataset or not. Additionally, if the training dataset is accessed via an API, bias treatment circuitry 210 may enforce restrictions at the API level, such that certain endpoints may be disabled or may be limited to particular operations (e.g., read-only access, or the like).

As shown by operation 504, the apparatus 200 includes means, such as processor 202, memory 204, communications hardware 206, bias treatment circuitry 210, or the like, for determining a bias removal technique. A bias removal technique may refer to any suitable method to mitigate the risk associated with the training dataset that comprises biased data elements. For example, some bias removal techniques may be data augmentation techniques, data removal, or the like. In some embodiments, a bias removal technique may be associated with the determined bias identification event type. For example, a less invasive bias removal technique may be applied by bias treatment circuitry 210 for a mild bias identification event type, while a more intensive bias removal technique (e.g., removing the biased data elements from the training dataset) may be implemented to mitigate the bias associated with a severe bias identification event type.

In some embodiments, bias treatment circuitry 210 may determine a bias removal technique by using a bias removal technique identification dataset. For example, the bias removal technique identification dataset may comprise of a plurality of key-value pars where the key is the bias identification event type, and the value is the bias removal technique to apply for the corresponding bias identification event type. Alternatively, the bias removal technique identification dataset may comprise a plurality of different types of keys that correspond to a particular bias removal technique. For example, the bias removal technique identification dataset may comprise keys associated with particular use-cases that is associated with the training dataset, the type of data elements included in the training dataset (e.g., tokens, n-grams, or the like), and/or the like. In such an embodiment, the value for each type of key is a bias removal technique. In some embodiments, the bias removal technique identification dataset may be stored in a local storage device (e.g., memory 204, storage device 108, or the like). As a result, bias treatment circuitry 210 may retrieve the bias removal technique identification dataset from a local storage device and subsequently utilize the determined bias identification event type to determine a corresponding bias removal technique to apply to the training dataset.

As shown by operation 506, the apparatus 200 includes means, such as processor 202, memory 204, bias treatment circuitry 210, or the like, for applying the bias removal technique to the training dataset. In some embodiments, the determined bias removal technique may be applied to the training dataset while the soft lock is applied to the training dataset. To perform the bias removal technique, bias treatment circuitry 210 may retrieve the training dataset from a local storage device and subsequently apply the determined bias removal technique to the training dataset.

For example, assume a word-embedding method is the root cause for the identification of a biased data element in a training dataset. In particular, a particular embedding method may produce an embedding (e.g., a particular data element included in the plurality of data elements) that lacks context-specific nuances (e.g., a biased embedding), which may cause the method learning model to learn biases associated with the biased embedding, and ultimately produce biased outputs. To mitigate biases learned in this manner, assume bias treatment circuitry 210 determined (in line with operation 504) that the bias removal technique to be applied to the training dataset is a data augmentation technique. As a result, bias treatment circuitry 210 may select the identified biased data elements and subsequently utilize a data augmentation model (e.g., a trained LLM) to generate by paraphrasing or rephrasing the identified biased data elements with known non-biased data elements. For example, the original sentence “the hotel staff was friendly and accommodating” may be paraphrased as “The staff at the hotel were welcoming and helpful,” and thus create a new training sample with similar sentiment but different wording is generated. In another example, if the bias removal technique determined in operation 504 describes removing the biased data elements, bias treatment circuitry 210 may simply remove the biased data element and/or any data elements associated with the biased data element from the training dataset. For example, if the biased data element associated with the training dataset is the token “unhappy,” the bias removal technique may remove the token “unhappy” in the training data set and the surrounding tokens that are included in the same sentence as the token “unhappy”.

As shown by operation 508, the apparatus 200 includes means, such as processor 202, memory 204, bias treatment circuitry 210, or the like, for determining whether the training dataset comprises biased data. To do so, bias treatment circuitry 210 may search for the biased data element(s) determined in operation 414. If bias treatment circuitry 210 does not identify the previously determined biased data element(s), bias treatment circuitry 210 may determine that the training dataset does not comprise biased data and the procedure may advance to operation 512. Alternatively, if the bias treatment circuitry 210 does find the biased data element in the training dataset, bias treatment circuitry 210 may determine that the training dataset still comprises biased data and may proceed to operation 510.

As shown by operation 510, the apparatus 200 includes means, such as processor 202, memory 204, bias treatment circuitry 210, or the like, for maintaining the soft lock. The soft lock may be maintained until the bias treatment circuitry 210 does not identify the determined biased data elements in the training dataset. As such, a supplemental action may be triggered in response to a failed bias mitigation action. For example, a triggered supplemental action may include initiating a bias removal technique to actually remove the biased data element, blacklisting the dataset, and/or the like.

As shown by operation 512, the apparatus 200 includes means, such as processor 202, memory 204, communications hardware 206, bias treatment circuitry 210, or the like, for storing the training dataset in a storage device. In addition, bias treatment circuitry 210 may remove the applied soft lock from the training dataset, such that the restrictions applied during the soft lock are removed.

In some embodiments, bias treatment circuitry 210 may publish the training dataset as a debiased training dataset. To do so, bias treatment circuitry 210 may generate documentation that describes the debiasing procedure taken in the above operations, the type of data included in the debiased dataset, the results and details describing the bias mitigation actions that were performed, and any preprocessing steps applied to the debiased dataset. In addition, the documentation may describe the license under which the debiased training dataset is released, the terms of use, and/or the like. In some embodiments, bias treatment circuitry 210 may convert, if needed, the debiased training data and documentation, to a commonly used format (e.g., csv, json, hdf5, or the like).

FIGS. 3-5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable an improved identification of bias. Example embodiments thus provide tools that overcome the problems faced by traditional machine learning bias identification methods. By avoiding the need to solely rely upon careful data collection and aggregation techniques to avoid collecting and aggregating biased training data, example embodiments thus provide a more comprehensive analysis of the data elements included in a training dataset, while also eliminating the possibility of human error that has been unavoidable in the past. Moreover, embodiments described herein avoid the use of post-hoc analysis approaches to identify bias in machine learning models, and thus enable the identification of particular data elements that correspond to biased data while a model training session occurs. Finally, by automating functionality that has historically required human analysis, the speed and consistency of the evaluations performed by example embodiments unlocks many potential new functions that have historically not been available, such as the ability to conduct near-real-time dispute resolution.

As these examples all illustrate, example embodiments contemplated herein provide technical solutions that solve real-world problems faced while identifying bias in machine learning models. And while identifying bias in machine learning models has been an issue for decades, the recently exploding amount of machine learning models used today has made this problem significantly more acute, as the demand for model interpretability has grown significantly even while the complexity of machine learning models has itself increased. At the same time, the recently arising ubiquity of Integrated Gradient techniques has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for dynamically identifying bias in a dataset, the method comprising:
receiving, by communications hardware, a fine-tuning request, wherein the fine-tuning request comprises a set of fine-tuning parameters;
retrieving, by a bias identification engine and based on the set of fine-tuning parameters, a machine learning model and a training dataset, wherein the training dataset comprises a plurality of data elements;
during a model training session, determining, by the bias identification engine and using a Uniform Discretized Integrated Gradient (UDIG) technique, that a data element corresponds to biased data;
in response to determining that the data element corresponds to biased data, determining, by the bias identification engine, a bias identification event, wherein the bias identification event corresponds to a bias identification event type and the bias identification event type is based on the data element that corresponds to the biased data;
determining, by bias treatment circuitry and based on the bias identification event type, a bias mitigation action; and
causing, by the bias treatment circuitry, performance of the bias mitigation action.

2. The method of claim 1, further comprising:
determining, by the bias identification engine and based on the training dataset, a discretized data element set, wherein the discretized data element set comprises a plurality of discretized data elements;
determining, by the bias identification engine and based on the discretized data element set, a baseline; and
generating, by the bias identification engine, a discretized path set, wherein the discretized path set comprises one or more paths from the baseline to the plurality of discretized data elements.

3. The method of claim 2, further comprising:
generating, by the bias identification engine and using the UDIG technique, an attribution score for each of the plurality of discretized data elements; and
determining, by the bias identification engine, an individual bias score for each data element included in the discretized data element set, wherein the individual bias score for each of the plurality of discretized data elements is based on its corresponding attribution score.

4. The method of claim 3, further comprising:
comparing, by the bias identification engine, the individual bias score for each of the plurality of discretized data elements to a bias identification threshold; and
determining, by the bias identification engine and based on the comparing, whether a data element corresponds to a biased data element.

5. The method of claim 3, wherein the UDIG technique is periodically applied to the discretized data element set during the model training session.

6. The method of claim 1, wherein causing performance of the bias mitigation action comprises:
applying, by the bias treatment circuitry and based on the bias identification event type, a soft lock to the training dataset;
determining, by the bias treatment circuitry and based on the bias identification event type, a bias removal technique;
applying, by the bias treatment circuitry, the bias removal technique to the training dataset;
determining, by the bias treatment circuitry, whether the training dataset comprises the biased data; and
in an instance in which the bias removal technique removed the biased data, storing, by the bias treatment circuitry, the training dataset in a storage device.

7. The method of claim 6, further comprising:
in an instance in which the training dataset comprises the biased data, maintaining, by the bias treatment circuitry, the soft lock.

8. The method of claim 1, wherein the machine learning model is a Large Language Model (LLM).

9. An apparatus for dynamically identifying bias in a dataset, the apparatus comprising:
communications hardware configured to receive a fine-tuning request, wherein the fine-tuning request comprises a set of fine-tuning parameters;
a bias identification engine configured to:
retrieve, based on the set of fine-tuning parameters, a machine learning model and a training dataset, wherein the training dataset comprises a plurality of data elements,
during a model training session, determine, using a Uniform Discretized Integrated Gradient (UDIG) technique that a data element corresponds to biased data, and
in response to determining that the data element corresponds to biased data, determine a bias identification event, wherein the bias identification event corresponds to a bias identification event type and the bias identification event type is based on the data element that corresponds to the biased data; and
bias treatment circuitry configured to:
determine, based on the bias identification event type, a bias mitigation action, and
cause performance of the bias mitigation action.

10. The apparatus of claim 9, wherein the bias identification engine is further configured to:
determine, based on the training dataset, a discretized data element set, wherein the discretized data element set comprises a plurality of discretized data elements;
determine, based on the discretized data element set, a baseline; and
generate a discretized path set, wherein the discretized path set comprises one or more paths from the baseline to the plurality of discretized data elements.

11. The apparatus of claim 10, wherein the bias identification engine is further configured to:
generate, using the UDIG technique, an attribution score for each of the plurality of discretized data elements; and
determine an individual bias score for each data element included in the discretized data element set, wherein the individual bias score for each of the plurality of discretized data elements is based on its corresponding attribution score.

12. The apparatus of claim 11, wherein the bias identification engine is further configured to:
compare the individual bias score for each of the plurality of discretized data elements to a bias identification threshold; and
determine, based on the comparing, whether a data element corresponds to a biased data element.

13. The apparatus of claim 11, wherein the UDIG technique is periodically applied to the discretized data element set during the model training session.

14. The apparatus of claim 9, wherein the bias treatment circuitry is further configured to:
apply, based on the bias identification event type, a soft lock to the training dataset;
determine, based on the bias identification event type, a bias removal technique;
apply the bias removal technique to the training dataset;
determine whether the training dataset comprises the biased data; and
in an instance in which the bias removal technique removed the biased data, store the training dataset in a storage device.

15. The apparatus of claim 14, wherein the bias treatment circuitry is further configured to:
in an instance in which the training dataset comprises the biased data, maintain the soft lock.

16. The apparatus of claim 9, wherein the machine learning model is a Large Language Model (LLM).

17. A computer program product for dynamically identifying bias in a dataset, the computer program product comprising a non-transitory computer-readable storage medium storing instructions that, when executed by an apparatus, cause the apparatus to:
receive a fine-tuning request, wherein the fine-tuning request comprises a set of fine-tuning parameters;
retrieve, based on the set of fine-tuning parameters, a machine learning model and a training dataset, wherein the training dataset comprises a plurality of data elements;
during a model training session, determine, using a Uniform Discretized Integrated Gradient (UDIG) technique that a data element corresponds to biased data;
in response to determining that the data element corresponds to biased data, determine a bias identification event, wherein the bias identification event corresponds to a bias identification event type and the bias identification event type is based on the data element that corresponds to the biased data;
determine, based on the bias identification event type, a bias mitigation action, and
cause performance of the bias mitigation action.

18. The computer program product of claim 17, wherein the instructions, when executed by the apparatus, further cause the apparatus to:
determine, based on the training dataset, a discretized data element set, wherein the discretized data element set comprises a plurality of discretized data elements;
determine, based on the discretized data element set, a baseline; and
generate a discretized path set, wherein the discretized path set comprises one or more paths from the baseline to the plurality of discretized data elements.

19. The computer program product of claim 18, wherein the instructions, when executed by the apparatus, further cause the apparatus to:
generate, using the UDIG technique, an attribution score for each of the plurality of discretized data elements; and
determine an individual bias score for each data element included in the discretized data element set, wherein the individual bias score for each of the plurality of discretized data elements is based on its corresponding attribution score.

20. The computer program product of claim 19, wherein the instructions, when executed by the apparatus, further cause the apparatus to:
compare the individual bias score for each of the plurality of discretized data elements to a bias identification threshold; and
determine, based on the comparing, whether a data element corresponds to a biased data element.
